(19) United States
(12) Patent Application Publication
(10) Pub. No.: US 2018/0322052 A1
(43) Pub. Date: Nov. 8, 2018

(54) DEFERRED WRITE BACK BASED ON AGE TIME

(71) Applicant: HEWLETT PACKARD ENTERPRISE DEVELOPMENT LP, Houston, TX (US)

(72) Inventor: Melvin K BENEDICT, Magnolia, TX (US)

(21) Appl. No.: 15/775,390

(22) PCT Filed: Feb. 19, 2016
(86) PCT No.: PCT/US2016/018759

§ 371 Date: May 10, 2018

(51) Int. Cl. G06F 12/0804; G06F 12/0866; G06F 12/123; G06F 12/1009

(52) U.S. Cl. CPC G06F 12/0804; G06F 12/0866; G06F 2212/2022; G06F 12/1009; G06F 2212/222; G06F 12/123

(57) ABSTRACT

Various examples described herein provide for deferred write back based on age time. According to some examples, an age time for a cached instance stored on a data cache is monitored and, based on the age time, a cache table entry for the cached instance may be modified to indicate that the cached instance is a candidate for a deferred write back period. A controller may monitor for a deferred write back period based on data activity of the data cache. During a deferred write back period, the cached instance may be written back from volatile memory to the non-volatile memory based on whether the cache table entry indicates that the cached instance has been modified and based on whether the cache table entry indicates that the cached instance is a candidate for the deferred write back period.

### BACKGROUND

With data caching, data is temporarily stored in a data cache (also known simply as a cache) so that future requests for that data can be served faster. Oftentimes, the data that is stored on cache has been recently used or created and is a copy of data stored elsewhere (e.g., persistent data storage device or a remote server) that would take longer to access in comparison to accessing the data from the cache. Data caching can be implemented and utilized in various computing contexts, such as data caching for a processor (e.g., central processing unit [CPU] cache), data caching for a data storage device (e.g., page caching for virtual memory), and web browsing (e.g., web proxy caching).

### BRIEF DESCRIPTION OF THE DRAWINGS

Certain examples are described in the following detailed description in sampled to the following drawings.

FIG. 1 is a block diagram illustrating an example data system for deferred write back according to the present disclosure.

FIGS. 2 and 3 are flowcharts illustrating example methods for deferred write back performed by a controller according to the present disclosure.

FIG. 4 is a block diagram illustrating an example computer system for deferred write back according to the present disclosure.

### DETAILED DESCRIPTION

Generally, a first data storage device functioning as data cache (hereafter, referred to as a data cache) of a computing device stores a copied version of data that is also stored on a second data storage device (e.g., non-volatile data storage device) of the computing device. Within this description, data stored on the second data storage device may be regarded as an original instance of the data, while the copied version of the data stored on the first data storage device may be regarded as a cached instance of the data. Accordingly, the cached instance of the data stored on the data cache corresponds to the original instance of the data stored on the second data storage device. The data cache may comprise a data storage device (e.g., volatile, random-access memory, such as a dynamic RAM [DRAM]) that has a faster data access rate than that of the second data storage device (e.g., non-volatile, persistent storage device, such as a hard disk drive or flash memory). During a data process, the cached instance of the data may be modified such that it is different from the original instance of the data stored on the second data storage device. Once the cached instance of the data has been modified, the data cache and the second data storage device are considered to be incoherent with respect to the data, and the cached instance may be regarded as dirty. Two common caching policies exist for maintaining coherency between the data cache and the second data storage device: write through; write through.

Under a write through policy, coherency between the data cache and the second data storage device may be maintained by writing modifications to the cached instance on the data cache and the original instance on the second data storage device at the same time. In this way, in the event of a power loss or crash of the computing device, preservation of the modified data on the data cache can be ensured on the second data storage device. In contrast, under a write back policy, coherency between the data cache and the second data storage device may be maintained by writing modifications to the cached instance on the data cache and the modified cached instance is written to the second data storage device at certain time intervals or conditions. For instance, a write back policy may indicate that a cached instance of data stored on the data cache is to be written back to the second data storage device when the cached data is to be evicted from the data cache (e.g., evicted based on infrequent use and need for storage space on the data cache).

Various examples described herein utilize a deferred/opportunistic write back (hereafter, deferred write back) policy, which can reduce the amount of modified data (e.g., dirty data) stored on the data cache and awaiting write back to the second data storage device, and which can do so with less performance impact than a write through policy. Examples described herein can be implemented with respect to different data systems including, but not limited to, virtual memory systems, Non-Volatile Dual In-line Memory Modules (NVDIMMs), and computer memory system (e.g., including a central processing unit [CPU] cache and main memory). For instance, in context of a NVDIMM, a first data storage device functioning as a data cache may comprise the dynamic random-access memory (RAM) of the NVDIMM, a second data storage device may comprise flash memory of the NVDIMM, and a controller of the NVDIMM can implement a deferred write back policy as described herein.

According to some examples, a first data storage device stores a cached instance of data, a second data storage device stores an original instance of the data, and a controller implements deferred write back. The first data storage device may comprise a volatile data storage device, and the second data storage device may comprise a non-volatile data storage device. The controller can monitor an age time for the cached instance and, based on the age time, modify (e.g., update) a cache table entry for the cached instance to indicate that the cached instance is a candidate for a deferred write back period.

As used herein, a cache table entry may be part of a cache table that facilitates management (e.g., stores attributes associated with) cached instances stored on the first data storage device (e.g., data cache or volatile memory). A cache table entry associated with a cached instance may, for instance, describe whether the cached instance is modified or whether the cached instance is a candidate for deferred write back as described herein.

The age time for the cached instance may be maintained by the controller, and may be based on (e.g., set or reset) the last time the cached instance was accessed (e.g., read or modified) on the first data storage device. The controller may monitor for the deferred write back period, and may do so based on data activity of the first data storage device. During the deferred write back period (e.g., when the controller detects the presence of the deferred write back period), the controller can cause the cached instance to be written back from the first data storage device to the second data storage device based on whether the cache table entry associated with the cached instance indicates: that the cached instance has been modified (e.g., the cached instance is dirty); and that the cached instance is a candidate for the deferred write back period. Once written back from the first data storage device to the second data storage device, the cache table entry for the cached instance may be modified to indicate that the cached instance is no longer considered modified in comparison to the original instance on the second data storage device (e.g., cache table entry is modified to indicate that the cached instance is clean).

As used herein, an instance of data (e.g., cached or original instance of data) may comprise a data block or a plurality of data blocks. Accordingly, a cached instance of data stored on a data cache may comprise a data block or comprise a plurality of data blocks copied from a non-volatile data storage device. Depending on the example, the size of the data block or of the plurality of data blocks may correspond in size to a single unit of data on the data cache (e.g., size of a cache line of the data cache, such as 64 bytes).

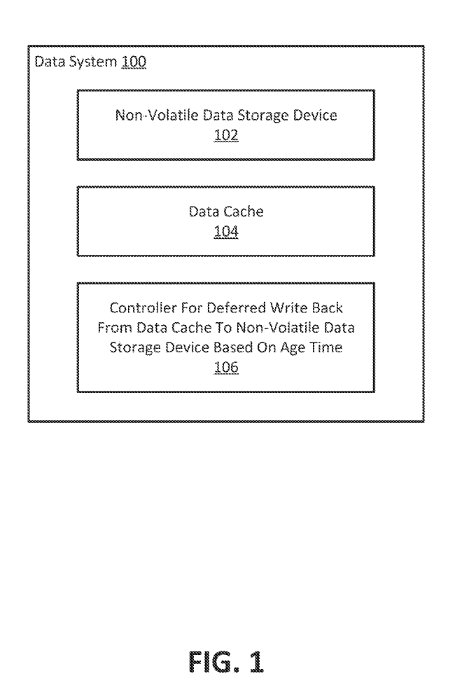

The following provides a detailed description of examples illustrated by FIGS. 1-4.

FIG. 1 is a block diagram illustrating an example data system 100 for deferred write back according to the present disclosure. As shown, the data system 100 includes a non-volatile data storage device 102, a data cache 104, and a controller 106. Depending on the example, the data system 100 may be part of a computing device, such as a desktop, laptop, hand-held computing device (e.g., personal digital assistants, smartphones, tablets, etc.), workstation, server, or other device that includes a processor. In particular examples, the data system 100 may work in conjunction with and may be part of a memory module (e.g., Non-Volatile Dual In-line Memory Module [NVDIMM]) of a computing device, a virtual memory system of a computing device, or a data caching system included by the computer device. In various examples, the components or the arrangement of components in the data system 100 may differ from what is depicted in FIG. 1.

As used herein, modules and other components of various examples may comprise, in whole or in part, hardware (e.g., electronic circuitry), or a combination of hardware and programming (e.g., machine-readable instructions, such as firmware), to implement functionalities described herein. For instance, a module may comprise a combination of machine-readable instructions, stored on at least one non-transitory machine-readable storage medium, and at least one processing resource (e.g., controller) to execute those instructions. The machine-readable instructions may comprise computer-readable instructions executable by a processor to perform a set of functions in accordance with various examples described herein. In another instance, a module may comprise electronic circuitry to perform a set of functions in accordance with various examples described herein.

The non-volatile data storage device 102 may comprise any data storage device that can maintain storage of data after being power cycled (e.g., going from online, to offline, and back to online). Accordingly, the non-volatile data storage device 102 may provide persistent storage of data on the data system 100 even when the non-volatile data storage device 102 stops receiving power. Examples of non-volatile data storage devices include, without limitation, a hard disk drive (HDD), a solid state drive (SSD), flash memory (e.g., comprising NAND or NOR gates). For certain examples, the data system 100 is part of a Non-Volatile Dual In-line Memory Module (NVDIMM), and the non-volatile data storage device 102 comprises the flash memory (e.g., NAND flash memory) portion of the NVDIMM. Additionally, for some examples, the non-volatile data storage device 102 functions as, or as part of, secondary memory in the data storage hierarchy of a computing device.

The data cache 104 may comprise any volatile data storage device that only maintains storage of data when the data storage device is receiving power (e.g., is online) or only a short time after it stops receiving power. Unlike the non-volatile data storage device 102, the data cache 104 provides limited or no persistent storage of data on the data system 100 after the data cache 104 stops receiving power. Examples of volatile data storage devices include, without limitation, dynamic random-access memory (DRAM), static random-access memory (SRAM), level one (L1) processor cache, and level two (L2) processor cache. For certain examples, the data system 100 is part of a Non-Volatile Dual In-line Memory Module (NVDIMM), and the data cache 104 comprises the RAM (e.g., DRAM) portion of the NVDIMM. Additionally, for some examples, the data cache 104 functions as, or as part of, primary memory in the data storage hierarchy of a computing device. For instance, the data cache 104 may comprise cache included by a central processing unit (CPU) of the computing device, or may comprise the main memory of the computing device.

According to various examples, the non-volatile data storage device 102 stores an original instance of data and the data cache 104 stores a cached instance of the data. The cached instance of the data stored on the data cache 104 may comprise a copy of the original instance of the data. The cached instance of the data may be stored on the data cache 104 by having the original instance of the data copied from the non-volatile storage device 102 to the data cache 104.

The cached instance of the data may be stored on the data cache 104 in response to a data operation that involves accessing the original instance of the data from the non-volatile data storage device 102. Additionally, the cached instance may be created for an original instance stored on the non-volatile data storage device 102 that has been recently accessed or frequently accessed by a data operation performed by the data system 100. For various examples, the cached instance of the data stored on the data cache 104 can be accessed faster than the original instance of the data (corresponding to the cached instance) can be accessed from the non-volatile data storage device 102.

Once stored on the data cache 104, the cached instance of the data stored on the data cache 104 may be modified by a data operation performed by the data system 100. As a result of the modification, the cached instance of the data may be inconsistent with respect to the original instance of the data stored and may be marked (e.g., as dirty) to be written back to the non-volatile data storage device 102. A cache table can include a cache table entry associated with the cached instance and that indicates whether the cached instance of the data has been modified since being copied from the non-volatile data storage device 102 to the data cache 104. For some examples, the controller 106 maintains the cache table and, in response to detecting a modification of the cached instance, updates the cache table entry for the cached instance to indicate that it has been modified (e.g., that it is dirty).

The controller 106 may facilitate the deferred write back of a cached instance of data from the data cache 104 to the non-volatile data storage device 102. According to some examples, the controller 106 monitors an age time for the cached instance stored on the data cache 104. The age time may indicate the last time the cached instance was accessed (e.g., read or modified) on the data cache 104. The age time for the cached instance may be managed or maintained (e.g., stored) by the controller 106, which may update the age time in response to detecting access of the cached instance on the data cache 104. The controller 106 may include the age time of the cached instance as part of a cache table entry associated with the cache instance. By maintaining an age time for a cached instance, the cached instance can be aged according to a predetermined interval (e.g., each refresh cycle of the data cache 104). Once the cached instance reaches a particular age time, the cached instance can qualify as a candidate for deferred write back to the non-volatile data storage device 102. The controller 106 may include a register for storing a constant value used to determine when an age time of a cached instance qualifies the cached instance as a candidate for deferred write back from the data cache 104 to the non-volatile data storage device 102. For instance, a cached instance may be a candidate for deferred write back when its associated age time meets or surpasses the value stored in a register of the controller 106.

According to various examples, the controller 106 manages an age time for a cached instance by updating (e.g., setting) the age time to a predetermined max value when the cached instance is accessed (e.g., read from or written to) on the data cache. After being set to the predetermined max value, the age time is periodically (e.g., at each refresh cycle of the data cache 104) decremented by a predetermined decrement value (e.g., integer value of 1) from a time the cached instance was last accessed on the data cache. Eventually, when the age time for the cached instance reaches a value of zero (or less), the cached instance may be considered a candidate for deferred write back period. For some examples, the controller 106 stops updating the age time once it reaches a value of zero (or less).

By aging cached instances as described herein, a set of cached instances having reached or surpassed a predetermined age (e.g., that not been accessed on the data cache 104 after predetermined amount of time) can be assigned to a deferred write back policy that causes the set of cached instances to be written back to the non-volatile data storage device 102 during a (deferred) time period when there is less data activity with respect to the data cache 104, the non-volatile data storage device 102, or both. The result of using the deferred write back policy can result in data performance improvement for the data system 100, which in turn may improve the data performance of a system that utilizes the data system 100.

For some examples, age time may only be maintained for those cached instances on the data cache 104 currently designated as modified (e.g., dirty). Additionally, for some examples, a single age time may be maintained for portions of the data cache 104 comprising a plurality of cached instances of data.

Based on the age time, the controller 106 may modify the cache table entry for the cached instance to indicate that the cached instance is a candidate for being written back to the non-volatile data storage device 102 during a deferred write back period. According to some examples, the cached table entry includes a field (e.g., bit field) that the controller 106 can modify (e.g., update) to indicate whether the associated cached instance is a candidate for the deferred write back period. For various examples, the field indicating whether the associated cached instance is a candidate for the deferred write back period is separate from a field that indicates whether the cached instance stored on the data cache 104 has been modified (e.g., is dirty).

The controller 106 may monitor for the deferred write back period based on data activity of the data cache 104. For various examples, the deferred write back period exists when data activity (e.g., write or read operations) of the data cache 104 is low. Additionally, for various examples, the deferred write back period exists when data activity (e.g., write or read operations) of the non-volatile data storage device is low. Depending on the example, low data activity may include where non-volatile data storage device is idle.

The set of conditions under which a deferred write back period exists may vary between different examples and, as such, the set of conditions monitored by the controller 106 to determine whether a deferred write back period exists can may also vary between different examples. For instance, the deferred write back period may exist based on activity of a memory management unit (MMU) associated with (e.g., included as part of) the data system 100. In such an instance, the controller 106 may actively monitor the state of the MMU to determine when a set of conditions exist for a deferred write back period. The deferred write back period may exist, for instance, when a memory queue of the MMU is half-full or less than half-full. Depending on the example, the controller 106 may be part of the MMU or may be a component separate from the MMU.

For some examples, the deferred write back period exists prior to a processor, associated with the data system 100, halting or entering a C-state. By doing so, some examples can avoid having the processor exit the C-state to have the modified cached instance copied from the data cache 104 to the non-volatile data storage device 102, or having the modified cached instance being lost when the processor halts.

During the deferred write back period, the controller 106 may cause the cached instance to be written back from the data cache 104 to the non-volatile data storage device 102 based on whether the cache table entry indicates that the cached instance has been modified and based on whether the cache table entry indicates that the cached instance is a candidate for the deferred write back period. In particular, upon detecting the presence of a deferred write back period, the controller 106 may determine whether the cache table entry of the cached instance indicates that the cached instance has been modified and whether the cache table entry indicates that the cached instance is a candidate for the deferred write back period. If the cache table entry (e.g., a bit field) indicates that the cached instance has been modified (e.g., is dirty) and that the cached instance is a candidate for the deferred write back period, the controller 106 causes the cached instance to be written back from the data cache 104 to the non-volatile data storage device 102.

For some examples, when the cached instance is written back from the data cache 104 to the non-volatile data storage device 102, the cached instance overwrites the original instance stored on the non-volatile data storage device 102. After the cached instance has been written back to the non-volatile data storage device 102, the controller 106 may modify the cached data entry to indicate that the cached instance is no longer modified (in comparison to the original instance). A cached instance that is no longer regarded as dirty may be regarded as clean.

For various examples, the controller 106 performs the operations described herein with respect to a plurality of cached instances on the data cache 104, each of which may have its own cache table entry or one that is shared by the plurality. In the context of a plurality of cached instances stored on the data cache 104, during the deferred write back period, the controller 106 may scan through a set of cache table entries associated with the plurality of cached instances to determine which cached instances should be written back from the data cache 104 to the non-volatile data storage device 102 and cause the write backs to occur accordingly.

For some such examples, where the data system 100 is included as part of a Non-Volatile Dual In-line Memory Module (NVDIMM), the controller 106 may cause a cached instance (e.g., dirty cached instance) to be copied (e.g., backed-up) from DRAM (functioning as the data cache 104) to NAND flash memory (functioning as the non-volatile data storage device 102) when: the controller 106 determines that the a deferred write back period exists (e.g., low activity by the DRAM); determines that the cached instance is modified (e.g., based on to its cache table entry); and determines that the cached instance is a candidate for deferred write back. In doing so, the NVDIMM can avoid having to perform write back more data from the DRAM to the NAND flash memory in the event the that the NVDIMM loses power.

For certain examples, causing the cached instance to be written back from the data cache 104 to the non-volatile data storage device 102 comprises causing the cached instance to be written back from the data cache 104 to an intermediate volatile storage device (not shown) that is associated with the non-volatile data storage device 102. Once the cached instance is stored on the intermediate volatile storage device (caused by the controller 106), it can be subsequently written from the intermediate volatile storage device to the non-volatile data storage device 102. For instance, the data system 100 may comprise a processor and a Non-Volatile Dual In-line Memory Module (NVDIMM) (not shown). The processor may include processor cache (e.g., L1 or L2) functioning as the data cache 104, the NVDIMM may include DRAM functioning as the intermediate volatile storage device, and the NVDIMM may include flash memory functioning as the non-volatile data storage device 102. As noted herein, the controller 106 may be part of the processor or the NVDIMM, or may be a separate component from the two. In such a context, the controller 106 may cause cached instance to be written back from the data cache 104 to the non-volatile data storage device 102 by causing the cached instance to be written from the processor cache to the DRAM. Eventually, a controller of the NVDIMM can cause the cached instance stored on the DRAM to be written from the DRAM to the flash memory (e.g., during an unexpected power loss to the NVDIMM, data content is moved from the DRAM to the flash memory).

Alternatively, for some examples, the data system 100 comprises a processor that includes a processor cache functioning as the data cache 104, the data system 100 comprises a Non-Volatile Dual In-line Memory Module (NVDIMM) (not shown) that includes flash memory functioning as the non-volatile data storage device 102, and the controller 106 causes the cached instance stored on the processor cache to be written back directly to the flash memory of the NVDIMM.

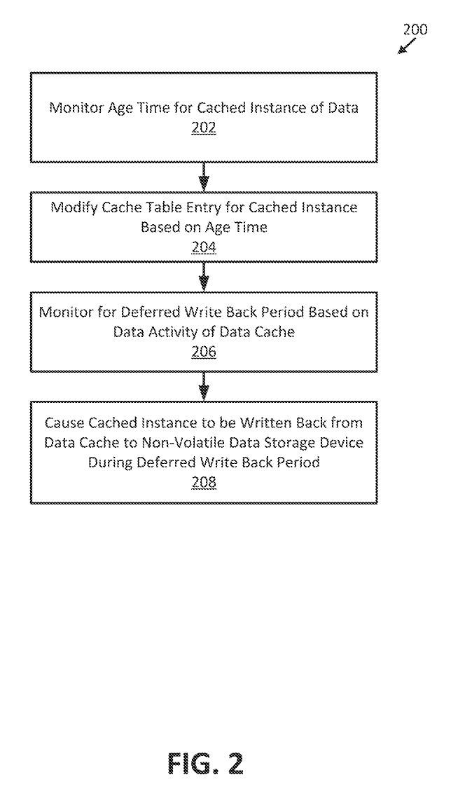

FIG. 2 is a flowchart illustrating an example method 200 for deferred write back performed by a controller according to the present disclosure. Although execution of the method 200 is described below with reference to components of the data system 100 of FIG. 1, execution of the method 200 by other suitable systems or devices may be possible. The method 200 may be implemented in the form of executable instructions stored on a machine-readable medium or in the form of electronic circuitry.

In FIG. 2, the method 200 may begin at block 202, with the controller 106 monitoring an age time for a cached instance of data stored on the data cache 104, an original instance of the data being stored on a non-volatile data storage device. The method 200 may continue to block 204 with the controller 106 modifying, based on the age time, a cache table entry for the cached instance to indicate that the cached instance is a candidate for a deferred write back period. The method 200 may continue to block 206 with the controller 106 monitoring for the deferred write back period based on data activity of the data cache. The method 200 may continue to block 208 with the controller 106 causing the cached instance to be written back from the data cache 104 to the non-volatile data storage device 102 during the deferred write back period if the cache table entry indicates that the cached instance has been modified and if the cache table entry indicates that the cached instance is a candidate for the deferred write back period.

As noted herein, when the cached instance is written back from the data cache 104 to the non-volatile data storage device 102, the cached instance overwrites the original instance stored on the non-volatile data storage device 102. Additionally, once the cached instance has been written back to the non-volatile data storage device 102, the controller 106 may modify the cached data entry for the cached instance to indicate that the cached instance is no longer modified (e.g., that it is clean).

For some examples,

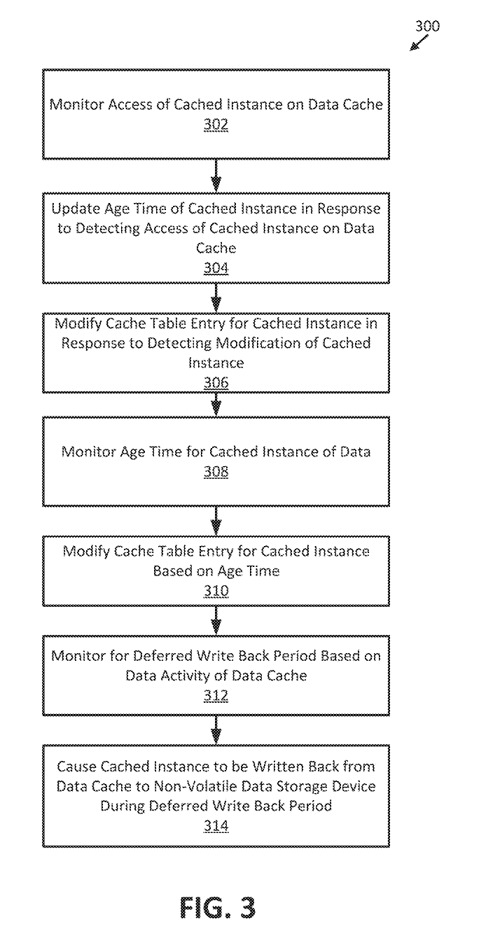

FIG. 3 is a flowchart illustrating an example method 300 for deferred write back performed by a controller according to the present disclosure. Although execution of the method 300 is described below with reference to components of the data system 100 of FIG. 1, execution of the method 300 by other suitable systems or devices may be possible. The method 300 may be implemented in the form of executable instructions stored on a machine-readable medium or in the form of electronic circuitry.

In FIG. 3, the method 300 may begin at block 302, with the controller 106 monitoring access of a cached instance on the data cache 104. The method 300 may continue to block 304 with the controller 106 updating (e.g., setting or resetting) the age time of the cached instance in response to detecting access (e.g., read or write) of the cached instance on the data cache 104. For some examples, the age time is updated to a predetermined max value when the cached instance is accessed on the data cache. Once set to a predetermined max value, the controller 106 may periodically (e.g., at each refresh cycle of the data cache 104) decrement the age time by a predetermined decrement value (e.g., integer value of 1) and may do so from a time the cached instance was last accessed on the data cache (e.g., written to or read from). Eventually, when the age time for the cached instance reaches a value of zero (or less), the cached instance may be considered a candidate for deferred write back period. Subsequently, when the controller 106 detects a set of conditions exist for a deferred write back period, the controller 106 can write back (from the data cache 104 to the non-volatile data storage device 102) at least some, if not all, of cached instances marked as candidates for the deferred write back period.

The method 300 may continue to block 306 with the controller 106 modifying (e.g., updating) a cache table entry for the cached instance in response to detecting a modification of the cached instance. The cache table entry may include a field (e.g., bit field) that indicates whether a cached instance on the data cache 104 has been modified (e.g., is dirty). Such a field may be modified by the controller 106 in response to detecting a modification of the cached instance. As noted herein, a field in the cache table entry indicating whether a cached instance has been modified may be separate from a field in the cached table entry indicating whether the cached instance is a candidate for a deferred write back period.

In FIG. 3, the method 300 may continue to block 308, 310, 312, and 314, which may be respectively similar to blocks 202, 204, 206, and 208 of the method 200 as described above with respect to FIG. 2.

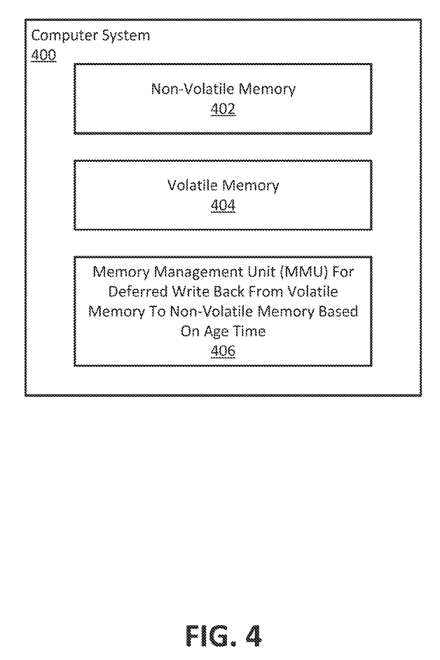

FIG. 4 is a block diagram illustrating an example computer system 400 for deferred write back according to the present disclosure. The computer system 400 may be any computing device having a processor, such as a desktop, laptop, hand-held computing device (e.g., personal digital assistants, smartphones, tablets, etc.), workstation, or server. As shown, the computer system 400 includes non-volatile memory 402, volatile memory 404, and a memory management unit (MMU) 406. In various examples, the components or the arrangement of components in the computer system 400 may differ from what is depicted in FIG. 4.

The non-volatile memory 402 may comprise any data storage device that can maintain storage of data after being power cycled (e.g., going from online, to offline, and back to online). Accordingly, the non-volatile memory 402 may provide persistent storage of data on the computer system 400 even when the non-volatile memory 402 stops receiving power. Examples of non-volatile memory include, without limitation, a hard disk drive (HDD), a solid state drive (SSD), flash memory (e.g., comprising NAND or NOR gates). For some examples, the non-volatile memory 402 functions as, or as part of, secondary memory in the data storage hierarchy of a computing device.

The volatile memory 404 may comprise any volatile data storage device that only maintains storage of data when the data storage device is receiving power (e.g., is online) or only a short time after it stops receiving power. The volatile memory 404 provides limited or no persistent storage of data on the computer system 400 after the volatile memory 404 stops receiving power. Examples of volatile data storage devices include, without limitation, dynamic random-access memory (DRAM), static random-access memory (SRAM), level one (L1) processor cache, and level two (L2) processor cache. For some examples, the volatile memory 404 functions as, or as part of, primary memory in the data storage hierarchy of a computing device. For instance, the volatile memory 404 may comprise cache included by a central processing unit (CPU) of the computer system 400, or may comprise the main memory of the computer system 400.

The memory management unit (MMU) 406 may facilitate deferred write back of the cached instance from the volatile memory 404 to the non-volatile memory 402. The MMU 406 may function as a paged memory management unit that receives memory references and performs translation of virtual memory addresses accessible by a processor (of the computer system 400) to physical memory addresses accessible by the processor. In a virtual memory environment, a cached instance a described herein may comprise a memory page including a contiguous block of virtual memory, the cache table as described herein may comprise a page table, and a cache table entry as described herein may comprise a page table entry.

Depending on the example, the MMU 406 may be part of a processor (e.g., central processing unit) of the computer system 400. Additionally, the MMU 406 may be part of a memory module of the computer system 400 that includes the non-volatile data storage device 402 and the volatile memory 404.

According to some examples, the MMU 406 monitors an age time for the cached instance. Based on the age time, the MMU 406 may modify a cache table entry for the cached instance to indicate that the cached instance is a candidate for a deferred write back period. The MMU 406 may monitor for the deferred write back period based on activity of the MMU 406. As noted herein, the deferred write back period may exist when a queue within the MMU 406 is half-full or less than half-full.

During the deferred write back period, the MMU 406 may cause (e.g., by instructing a processor of the computer system 400 or the volatile memory 404) the cached instance to be written back from the volatile memory 404 to the non-volatile memory 402 based on whether the cache table entry indicates that the cached instance has been modified and based on whether the cache table entry indicates that the cached instance is a candidate for the deferred write back period. For instance, during the deferred write back period, the MMU 406 may cause the cached instance to be written back to the non-volatile memory 402 when the MMU 406 determines, based on the cached instance has been modified and is a candidate for the deferred write back period based on its associated cache table entry. For some examples, the cache table and the cache table entry are maintained by the MMU 406.

In the foregoing description, numerous details are set forth to provide an understanding of the subject disclosed herein. However, various examples may be practiced without some or all of these details. Some examples may include modifications and variations from the details discussed above. It is intended that the appended claims cover such modifications and variations.

1. A data system, comprising:
a non-volatile data storage device to store an original instance of data;
a data cache to store a cached instance of the data; and
a controller to:
monitor an age time for the cached instance;
based on the age time, modify a cache table entry for the cached instance to indicate that the cached instance is a candidate for a deferred write back period;
monitor for the deferred write back period based on data activity of the data cache; and
during the deferred write back period, cause the cached instance to be written back from the data cache to the non-volatile data storage device based on whether the cache table entry indicates that the cached instance has been modified and based on whether the cache table entry indicates that the cached instance is a candidate for the deferred write back period.

2. The data system of claim 1, wherein the controller is to modify the cache table entry to indicate whether the cached instance has been modified.

3. The data system of claim 1, wherein the deferred write back period exists when the data activity of the data cache is low.

4. The data system of claim 1, wherein the deferred write back period exists when data activity of the non-volatile data storage device is low.

5. The data system of claim 1, wherein the deferred write back period exists based on activity of a memory management unit (MMU).

6. The data system of claim 1, wherein the deferred write back period exists prior to a processor halting or entering a C-state, the processor being associated with the data system.

7. The data system of claim 1, wherein the controller is to manage the age time by:
updating the age time to a predetermined max value when the cached instance is accessed on the data cache; and
periodically decrementing the age time, by a predetermined decrement value, from a time the cached instance was last accessed on the data cache.

8. The data system of claim 1, wherein the controller modifying the cache table entry, based on the age time, to indicate that the cached instance is a candidate for the deferred write back period comprises the controller modifying the cache table entry to indicate that the cached instance is a candidate for the deferred write back period when the age time is zero.

9. The data system of claim 1, wherein the data system included by a Non-Volatile Dual In-line Memory Module (NVDIMM), the data cache comprises Dynamic Random Access Memory (DRAM), and the non-volatile data storage device comprises a flash memory.

10. A method, comprising:
monitoring an age time for a cached instance of data stored on a data cache, an original instance of the data being stored on a non-volatile data storage device;
modifying, based on the age time, a cache table entry for the cached instance to indicate that the cached instance is a candidate for a deferred write back period;
monitoring for the deferred write back period based on data activity of the data cache; and
during the deferred write back period, causing the cached instance to be written back from the data cache to the non-volatile data storage device if the cache table entry indicates that the cached instance has been modified and if the cache table entry indicates that the cached instance is a candidate for the deferred write back period.

11. The method of claim 10, comprising in response to detecting modification of the cached instance stored on the data cache, modifying the cache table entry for the cached instance to indicate that the cached instance has been modified.

12. The method of claim 10, comprising:
monitoring access of the cached instance on the data cache; and
in response to detecting access of the cached instance from data cache, updating the age time for the cached instance, the age time indicating a time of last access of the cached instance on the data cache.

13. The method of claim 10, wherein causing the cached instance to be written back from the data cache to the non-volatile data storage device comprises causing the cached instance to be written back from the data cache to an intermediate volatile storage device associated with the non-volatile data storage device, wherein the cached instance is subsequently written from the intermediate volatile storage device to the non-volatile data storage device.

14. A computer system, comprising:
a non-volatile memory to store an original instance of a data;
a volatile memory to store a cached instance of the data; and
a memory management unit (MMU) to:
monitor an age time for the cached instance;
based on the age time, modify a cache table entry for the cached instance to indicate that the cached instance is a candidate for a deferred write back period;
monitor for the deferred write back period based on activity of the MMU; and
during the deferred write back period, cause the cached instance to be written back from the volatile memory to the non-volatile memory based on whether the cache table entry indicates that the cached instance has been modified and based on whether the cache table entry indicates that the cached instance is a candidate for the deferred write back period.

15. The computer system of claim 14, wherein the deferred write back period exists when a queue of the MMU is half-full or less than half-full.
